(19) United States
(12) Patent Application Publication
(10) Pub. No.: US 2007/0242634 A1
(43) Pub. Date: Oct. 18, 2007

(54) METHOD AND APPARATUS FOR MESSAGE TRANSMISSION WITHIN A COMMUNICATION SYSTEM

(75) Inventors: George Calcev, Hoffman Estates, IL (US); Stephen P. Emeott, Rolling Meadows, IL (US); Hrishikesh Gossain, Apopka, FL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/379,081

(22) Filed: Apr. 18, 2006

(51) Int. Cl. H04B 7/185

(52) U.S. Cl. 370/318; 370/338

(57) ABSTRACT

The proposed method and apparatus reduces an amount of power required for nodes to both transmit and receive messages. In particular, broadcast packets are sent in an awake period (ATIM window) if the length of these messages is small. Because these packets do not need acknowledgment or they do not expect immediate reply, they may be broadcast in the ATIM window. Since all nodes are awake during the ATIM window, nodes may receive messages during this period of time which they ordinarily would need to stay awake to receive in the sleep period (post ATIM window).

### FIELD OF THE INVENTION

The present invention relates generally to message transmissions and in particular, to a method and apparatus for message transmission within a communication system.

### BACKGROUND OF THE INVENTION

Power saving in ad-hoc networks plays an important role in social acceptance of ad-hoc network applications on the market. Battery power continues to be a constrained resource and therefore power management in wireless networks remains an important issue. This issue is particularly important in multi-hop ad-hoc networks where each user relies on each other for message relaying. Therefore, a need exists for a method and apparatus for message transmission within a communication system that reduces an amount of power required for nodes to both transmit and receive the message.

### BRIEF DESCRIPTION OF THE DRAWINGS

FIG. 1 is a block diagram of a communication system.

FIG. 2 illustrates a beacon interval.

FIG. 3 is a block diagram of a node of FIG. 1

FIG. 4 is a flow chart showing operation of the node of FIG. 3.

FIG. 5 is a flow chart showing operation of the node of FIG. 3.

### DETAILED DESCRIPTION OF THE DRAWINGS

In order to address the above-mentioned need, a method and apparatus is provided herein for message transmission within a communication system. The proposed method and apparatus reduces an amount of power required for nodes to both transmit and receive messages. In particular, broadcast packets are sent in an awake period (ATIM window) if the length of these messages is small. Because these packets do not need acknowledgment or they do not expect immediate reply, they may be broadcast in the ATIM window. Since all nodes are awake during the ATIM window, nodes may receive messages during this period of time which they ordinarily would need to stay awake to receive in the sleep period (post ATIM window).

In a communication system employing an awake interval where all nodes remain awake to receive and transmit messages, and also employing a sleep interval where nodes may sleep if they have no messages to receive, the present invention comprises a method for message transmission. The method comprises the steps of determining that a broadcast message is to be transmitted to a node, determining if the broadcast message size is below a threshold, and transmitting the broadcast message during the awake interval if the broadcast message is below the threshold, otherwise transmitting the broadcast message during the sleep interval.

The present invention additionally encompasses a method for message reception. The method comprises the steps of receiving a broadcast message during the awake interval if the broadcast message length is below a threshold, otherwise receiving the broadcast message during the sleep interval.

The present invention additionally encompasses an apparatus for message transmission. The apparatus comprises logic circuitry determining that a broadcast message is to be transmitted to a node and determining if the broadcast message size is below a threshold. The apparatus additionally comprises transmission circuitry transmitting the broadcast message during the awake interval if the broadcast message is below the threshold, otherwise transmitting the broadcast message during the sleep interval.

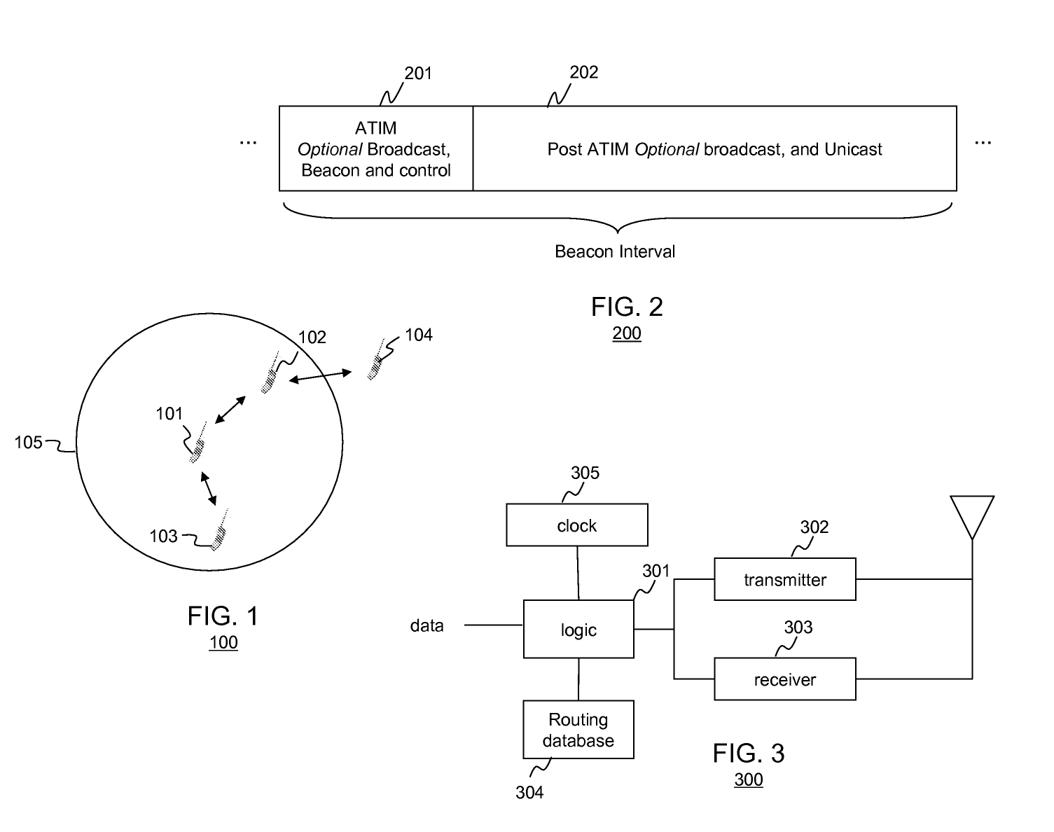

Turning now to the drawings, wherein like numerals designate like components, FIG. 1 is a block diagram of communication system 100. Communication system 100 comprises a plurality of coverage areas 105 (only one shown centered around node 101) each comprising a plurality of nodes 102-103 within the transmission range of central node 101. In the preferred embodiment of the present invention, communication system 100 utilizes an IEEE 802.11 communication system protocol, however, in alternate embodiments communication system 100 may utilize other wideband cellular communication system protocols such as, but not limited to, a next generation Orthogonal Frequency Division Multiplexed (OFDM) or multicarrier based architecture, or a TDMA or direct sequence CDMA system architecture.

During operation node 101 generates data destined to node 104. As is evident nodes may be inside or outside the transmission range of the node 101. When outside the range of the node 101, the out-of-range node (e.g., node 104) may receive its transmissions from node 101 through intervening nodes (e.g., node 102). Thus, node 101 may transmit data to node 102, with node 102 eventually transmitting the data to node 104.

Alternatively, node 101 may receive data destined to node 102 from node 103. If node 102 is the only destination for the data at node 101, then node 101 will address the data using a unicast destination address. If the data at node 101 is destined for multiple destination nodes (e.g., nodes 102-103), then node 101 will address the data using a broadcast destination address.

Nodes will alternate sleep (power-down) intervals with awaken (power-up) intervals while preserving connectivity with other nodes. The actual 802.11 standard (1999) specifies a synchronization algorithm that requires all the participants (nodes) in an ad-hoc network to share a common clock and a common sleep pattern, providing a common awake period during which connectivity between nodes is guaranteed. The nodes are synchronized using periodic beacons broadcast after every ad-hoc beacon interval, where each node competes for sending beacons. Each beacon carries information about the sender's timestamp and the beacon interval. After beacons are sent, all the nodes remain awake for the duration of ad-hoc traffic indication (ATIM) window. During the ATIM window the nodes that have messages to send (either unicast or broadcast) use ATIM announcement packets to inform their destination nodes that a data packet will come. After the expiration of ATIM window the nodes that have data to send or receive (determined from ATIM announcement packets) will remain awake for a post ATIM window. All other nodes will power down until the beacon interval expires when the above steps repeat. This is shown in FIG. 2.

As illustrated in FIG. 2, each beacon interval 200 comprises ATIM window 201 and post ATIM window 202. As discussed, during ATIM window 201, all nodes will power up to transmit any ATIM packets to their destination nodes. Additionally, each node will listen for ATIM packets from source nodes and also broadcast beacons for synchronization. All nodes will then determine if they have messages (broadcast or unicast) to send or receive during post ATIM window 202. If no messages are to be sent or received for a particular node, the particular node will power down for post ATIM window.

As discussed above, battery power continues to be a constrained resource and therefore the power management in wireless networks remains an important issue. In order to address this issue and reduce the amount of time nodes remain awake during the post ATIM window 202, nodes implemented in accordance with the present invention transmit broadcast packets, including Hello and Route request messages or multicast data frames. As known in the art, broadcast packets comprises data that is sent to at least one node, and does not require a response from the node receiving the data. The broadcast packets are sent in ATIM window 201 if the length of these messages is small. Because these packets do not need acknowledgment or they do not expect immediate reply, they may be broadcast in ATIM window 201. Since all nodes are awake during ATIM window 201, nodes may receive messages during this period of time which they ordinarily would need to stay awake to receive in post ATIM window 202.

FIG. 3 is a block diagram of node 300 used to transmit and receive information as shown in FIG. 2. As shown, node 300 comprises logic circuitry 301, transmit circuitry 302, receive circuitry 303, database 304, and clock 305. Logic circuitry 301 preferably comprises a microprocessor controller, such as, but not limited to a Freescale PowerPC microprocessor. Database 304 comprises standard random access memory and serves to store routing information such as node addresses and intervening nodes. Transmit and receive circuitry 302-303 are common circuitry known in the art for communication utilizing a well known network protocols, and serve as means for transmitting and receiving messages. For example, transmitter 302 and receiver 303 are preferably well known transmitters and receivers that utilize an IEEE 802.11 network protocol. Other possible transmitters and receivers include, but are not limited to transceivers utilizing Bluetooth, 3 GPP, or HyperLAN protocols.

Because beacon interval 200 is comprised of ATIM window 201 (where all nodes 101-104 remain awake) and post-ATIM window 202 (where nodes may sleep if they have no messages to transmit or receive), logic circuitry 301 will need to determine whether data is to be transmitted in either the ATIM window or the post-ATIM window. Logic circuitry 301 will instruct transmitter 302 to transmit ATIM control frames (within the ATIM window) having addresses for those nodes that are to stay awake for messages outside the ATIM window. When a node receives an ATIM control frame with its address, it will know to stay awake during the post ATIM window in order to receive data.

As discussed above, when transmitting broadcast messages (and all messages not requiring a response), logic circuitry 301 will determine if the size of any broadcast message to be transmitted is small (below a system threshold limiting the size of messages transmitted during the ATIM window). If the length of any broadcast message to be transmitted is small, then the logic circuitry 301 will transmit at least one of the small messages during the ATIM window 201. Nodes that receive a broadcast message during ATIM window 201 will now be allowed to sleep during post-ATIM window 202 if they have no further messages to receive (e.g. “More Data” bit in the frame control field of broadcast data frame header set to FALSE).

It should be noted that broadcast messages as envisioned comprises those messages that are generated/consumed by the communication layers above the MAC layer, as opposed to standard ATIM control messages generated/consumed at the MAC layer only for the purpose to inform that data (broadcast) messages will come after ATIM window.

If, however, logic circuitry 301 determines that all broadcast messages are too large to be transmitted in ATIM window 201, logic circuitry 301 will transmit ATIM control frames to the nodes that are to receive the broadcast message in the post-ATIM window. The control frames notifies the nodes that a broadcast message is to be transmitted and that they must remain awake during post-ATIM window 202 to receive the broadcast message. The broadcast message will then be transmitted within post-ATIM window 202.

As one of ordinary skill in the art will recognize, for unicast messages (and for all messages that require a response), logic circuitry 301 will instruct transmitter 302 to transmit ATIM control frames (within the ATIM window) having addresses for those nodes that are to stay awake for messages outside the ATIM window. All messages that require a response will then be transmitted by transmitter 302 in post ATIM window 202.

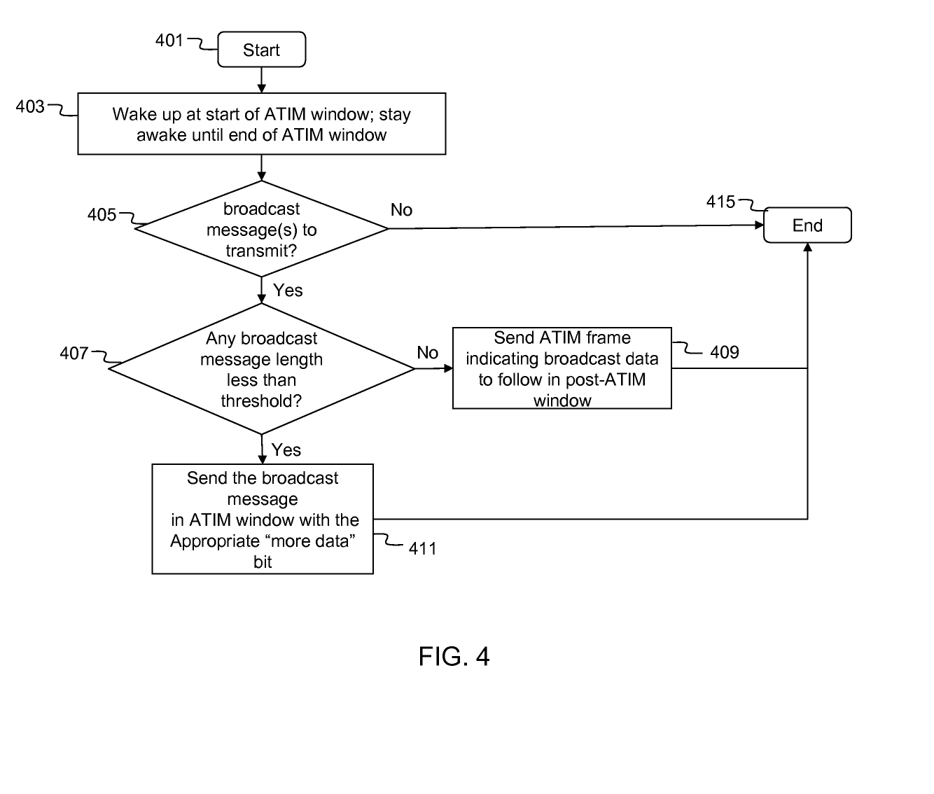

FIG. 4 is a flow chart showing operation of node 300 when transmitting data in the ATIM window. As discussed above, node 300 operates in a communication system employing an awake interval where all nodes remain awake to receive and transmit messages, and also employing a sleep interval where nodes may sleep if they have no messages to receive. Although not necessary, in the preferred embodiment of the present invention only one broadcast message and/or ATIM announcement are sent during the ATIM window.

The logic flow begins a step 401. At step 403, logic circuitry 301 accesses clock 305 and instructs all circuitry within node 300 to awake for the start of the awake interval (e.g., ATIM window) and stay awake until the end of the awake window. At step 405, logic circuitry determines if it has broadcast data to transmit. As discussed above, a broadcast message comprises a message that does not require a response from a node, and is typically addressed to more than one node using an address set aside for either broadcast or multicast transmissions. If, at step 405, logic circuitry determines that it does not have broadcast messages to send, the logic flow ends at step 415. However, if a broadcast message is to be sent, the logic flow continues to step 407 where logic circuitry determines if a current broadcast message size is below a threshold. As discussed, the step of determining if the broadcast message size is below the threshold comprises the step of determining if the length of the broadcast message is less than a system threshold, which in the preferred embodiment of the present invention is set to one or two times the length of an ATIM control frame, depending upon the size of the ATIM window. The threshold assures that the broadcast message will fit within the awake interval. Thus, at step 407, logic circuitry determines if the broadcast message will fit within the awake interval.

If, at step 407 it is determined that the broadcast message is not less that the threshold, the logic flow continues to step 409 where an indication is sent by transmitter 302 that the broadcast message will follow in the sleep interval (post-ATIM window). However, if at step 407 it is determined that the broadcast message is less than the threshold, then the logic flow continues to step 411 the broadcast message is transmitted by transmitter 302 in the ATIM window. The logic flow then ends at step 415. It should be noted that within the broadcast message exists a “more data” bit that indicates whether or not additional data will follow in the post-ATIM window. Therefore, the logic flow does not need to return to step 409.

While not covered in the above flow chart, one of ordinary skill in the art will recognize that non-broadcast message indications (i.e., unicast message indications) will be sent during the ATIM window. Since all unicast messages require a response from the receiver indicating that it has received the indication, the unicast messages will all be transmitted during the sleep interval. Thus, during the ATIM window, logic circuitry 301 will determining if a non-broadcast message is to be transmitted to the node and transmits any non-broadcast message during the sleep interval.

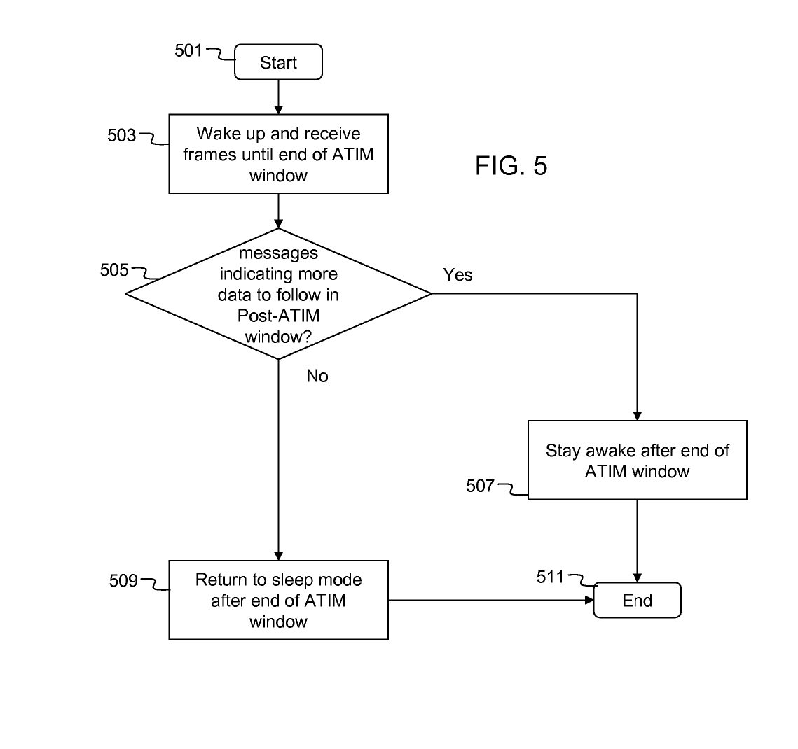

FIG. 5 is a flow chart showing operation of node 300 when receiving data. As discussed above, node 300 operates in a communication system employing an awake interval where all nodes remain awake to receive and transmit messages, and also employing a sleep interval where nodes may sleep if they have no messages to receive. The logic flow begins at step 501. At step 503, logic circuitry 301 accesses clock 305 and wakes up all circuitry until the end of the awake interval (ATIM window). During this time period receiver 303 may receiving a broadcast message if the broadcast message length is below a threshold (e.g., the length of the broadcast message is less than a system threshold, which in the preferred embodiment of the present invention is set to one or two times the length of an ATIM control frame, depending upon the size of the ATIM window). At step 505 logic circuitry 301 determines if a message was received indicating more data is to follow in the sleep interval (post-ATIM window), and if so the logic flow continues to step 507, otherwise, logic circuitry 301 instructs node 300 to return to sleep mode after the end of the ATIM window. The logic flow ends at step 511

At step 507, node 300 remains awake for the sleep interval (post-ATIM window) and may receive broadcast messages and/or non-broadcast (unicast) messages during the sleep interval.

The following text is provided to give information for implementation of the present invention within the IEEE 802.11 communication system protocol.
LWMP—light weight mesh point
TSPEC—traffic specification

Power Management in a Mesh (Optional)

This sub-clause describes the power management mechanisms to use within a mesh network

Basic Approach

A mesh point supporting power save operation may either operate in an active or power save state. The mesh point will advertise its power save state to all neighboring mesh points by using its beacons and by sending a Null-Data frame with the power save (PS) bit active.

Mesh points in power save mode shall periodically listen for delivery traffic indication message (DTIM) beacons. Mesh point waking to receive a beacon will stay awake for a minimum period of ATIM window as indicated in their beacons, before returning to sleep.

Mesh points in power save mode shall also wakeup according to any negotiated schedule as part of traffic specification (TSPEC) setup with other mesh points. The mesh point will remain awake until the end of service period

Mesh point wishing to communicate with mesh points that are in power save would buffer the traffic targeted for these mesh points. They could deliver the traffic to the mesh point in one of 4 ways:
1. Send traffic to these mesh points only on agreed schedules as negotiated as part of APSD (Automatic Power Save Delivery) TSPEC setup
2. Send directed or broadcast ATIM packets to mesh point in power save during ATIM window in order to signal them to remain awake and wait for further traffic
3. Send a single null data packet to mesh point in power save during their ATIM window in order to reactivate a flow that has been suspended or to signal power save state change.
4. Send a single, short broadcast or multicast frame to mesh points during the ATIM window as described in Section 1.1.4

All non-AP mesh points (MPs) that support the mesh power save mechanism shall support synchronization as described in 6.11. Such non-AP MPs shall become synchronizing MPs if they are not already, if they receive beacons or probe responses with the “Request Synchronization from Peers” bit set in the ‘Synchronization Capability’ field of WLAN Mesh Capability information element (IE). All non-AP MPs that intend to enter power save state shall be synchronizing MPs, as defined in clause 6.11, and shall request synchronization from peers through the ‘synchronization capability’ field in their WLAN Mesh Capability IE. MAPs may support power save with or without being synchronizing MPs (that is, even when acting as unsynchronizing MPs).

Any MP that wishes to communicate with an unsynchronizing MAP, and enters PS mode shall wake up for the BSS DTIM beacon of the MAP. If such an MP wishes to communicate with more than one unsynchronizing MAP, it shall wake up for the BSS DTIM beacons for each such MAP in addition to any Mesh DTIM TBTT which may be scheduled for its synchronizing MP neighbors.

LW-MPs that aim to communicate with their unsynchronizing MAP neighbors and enter PS state must wake up for the BSS DTIM beacons for each such MAP in addition to any Mesh DTIM TBTT which may be scheduled for its synchronizing MP neighbors. Alternatively, a lightweight MP may associate with a MAP as a simple STA if it intends to enter PS mode.

The PS operation of an unsynchronizing MAP is based upon IEEE 802.11 infrastructure power management operation. In particular, STAs (including MPs) changing Power Management mode shall inform the MAP of this fact using the Power Management bits within the Frame Control field of transmitted frames. Unsynchronizing MAP shall not arbitrarily transmit MAC service data units (MSDUs) to MP operating in a PS mode, but shall buffer MSDUs and only transmit them at designated times (during BSS DTIM intervals).

Initialization of Power Management within a Mesh

The following procedure shall be used to initialize power management within a new mesh or on joining an existing mesh.
A mesh point that joins a mesh will update its ATIM window and DTIM interval according to the received values from beacons in the mesh
The mesh point sets its own power save state and advertises it in its beacons
A mesh point that creates a mesh would set the values of ATIM window, DTIM interval and power save state and advertise them in its beacons
The start of the ATIM window will be measured from TBTT

Mesh Point Power State Transitions

A mesh point may change its state to power save only if the following conditions are fulfilled:
The mesh point supports power save operation
All of the mesh points that the mesh point is connected to (has peer relationships) are capable of transmitting traffic to mesh points operating in power save mode

A mesh point changing power mode to power save will inform all it's mesh neighbors of the change by sending a Null-Data frame to a broadcast address with the power bit in its frame control header set. The packet will be sent during the ATIM window of a DTIM beacon and will be repeated at least twice on two different DTIM intervals. If a beacon is received with the PS state bit of the specific MP in Neighbor list not updated, the MP will continue to send the Null-Data packet on the next DTIM. The mesh point will include a Mesh PS IE with a value of Powersave in its following beacons.

A mesh point changing power mode to active will inform all its mesh neighbors of the change by sending a Null-Data frame to a Broadcast address with the power bit in its frame control header cleared. The packet will be sent during the ATIM window of a DTIM beacon and will be repeated twice on two consecutive DTIM intervals. The mesh point will include a Mesh PS IE with a value of Active in its following beacons. The mesh point will transfer to the active state immediately with no relation to when the Beacons will be sent.

A mesh point operating in power save mode will set the power bit in the frame control header of every outgoing frame. A mesh point operating in active mode will clear the power bit in the frame control header of every out going frame.

A mesh point in power save mode will transition between awake and doze states according to the following rules:
A mesh point will enter awake state prior to every TBTT that matches the mesh DTIM interval
A mesh point that entered the awake state due to the DTIM TBTT event and had not sent an ATIM, a broadcast frame or a multicast frame, and did not receive a directed or multicast ATIM, a broadcast frame or a multicast frame may return to the Doze state following the end of the ATIM window
If a mesh point received an ATIM, broadcast or multicast frame it may return to doze state after receiving a packet with the more bit in the control field cleared from all the sources that sent an ATIM, broadcast or multicast frame during the ATIM window.
A mesh point receiving a broadcast or multicast frame during the ATIM window with the more data bit of its control field cleared may return to the doze state either following the end of the ATIM window or after receiving a packet with the more bit in the control field cleared from all other active sources, whichever comes later.
A mesh point that transitions to the awake state may transmit a beacon, but this would not prevent it from returning to doze state following the ATIM window
In addition a mesh point will enter awake state prior to every agreed schedule as negotiated as part of a periodic APSD TSPEC exchange with other mesh points
A mesh point entering awake state may return to doze state after receiving and/or sending a directed frame to/from the specific flow for which this schedule was set with EOSP bit set or with the expiration of the maximal service interval for that flow.
A mesh point may transition to awake state if it has traffic to transmit at any given point of time

Frame Transmission

The following description applies to mesh points that are supporting power save operation. Mesh points that do not support this capability do not have to track the power save state of other mesh points and will only use the standard procedure for frame transmission.

A mesh point will store information on the power save state of all its neighbors by monitoring their beacon's Mesh PS IE and by extracting information from the neighbor list IE in beacons of other MPs.

A mesh point considers the mesh to operate in a powersave mode if any one of its neighbors is operating in the powersave mode. In a mesh that operates in the Active state, frames may be sent at any time to other mesh points. For a mesh that operates in a power save scheme the following rules apply for transmission:
All broadcast and multicast traffic will be buffered by mesh points that perceive the mesh to operate in power save mode. These packets will be transmitted only on DTIM intervals
All unicast traffic targeted to mesh points in power save will be buffered.

These packets will be transmitted only on the DTIM interval.
The only types of frames mesh points may transmit during the ATIM window are ACK, clear to send (CTS), request to send (RTS), ATIM, Beacon, broadcast or multicast MAC protocol data unit (MPDU) and & Null Data.
A mesh point may transmit one short broadcast or multicast MPDU during the ATIM window if the MAC frame length of the MPDU is less than dot11shortMulticastFrameLengthLimit. If the mesh point has more than one broadcast or multicast frame to transmit, it should set the more data bit of the broadcast or multicast frame transmitted during the ATIM window and contend for the channel following the end of the ATIM window to transmit the additional frames. Therefore a mesh point (base station) may determine that a plurality of broadcast messages are to be transmitted to a plurality of nodes and that multiple broadcast messages have a length that is below a threshold. Only a single broadcast message that is below the threshold will be transmitted during the awake interval, the remaining broadcast messages that are below the threshold will be transmitted during the sleep interval.
Mesh points that transmit to mesh points in power save state (including broadcast and multicast) will set the More bit in frame control headers to indicate if more frames are to be transmitted for the specific destination.
All other aspects of ATIM based transmission are as defined in 802.11 specification section 11.2.2.4
For traffic that belongs to a flow for which an APSD TSPEC and schedule was setup with another mesh point, the transmission will be performed according to the agreed schedule.

While the invention has been particularly shown and described with reference to a particular embodiment, it will be understood by those skilled in the art that various changes in form and details may be made therein without departing from the spirit and scope of the invention. For example, the above power-savings scheme can virtually be used in any single-hop or multi-hop ad-hoc or mesh network where CSMA-CA channel access is used. It provides drastically improvement of the battery life and of the end-to-end delay when compared with the actual 802.11 power-savings techniques. It is intended that such changes come within the scope of the following claims.

1. In a communication system employing an awake interval where all nodes remain awake to receive and transmit messages, and also employing a sleep interval where nodes may sleep if they have no messages to receive, a method for message transmission, the method comprising the steps of:
determining that a broadcast message is to be transmitted to a node;
determining if the broadcast message size is below a threshold; and
transmitting the broadcast message during the awake interval if the broadcast message is below the threshold, otherwise transmitting the broadcast message during the sleep interval.

2. The method of claim 1 wherein the step of determining if the broadcast message size is below the threshold comprises the step of determining if the broadcast message will fit within the awake interval.

3. The method of claim 1 wherein the step of transmitting the broadcast message during the awake interval comprises the step of transmitting the broadcast message during an IEEE 802.11 ad-hoc traffic indication (ATIM) window.

4. The method of claim 1 wherein the step of transmitting the broadcast message during the sleep interval comprises the step of transmitting the broadcast message during an IEEE 802.11 post ad-hoc traffic indication (ATIM) window.

5. The method of claim 1 further comprising the steps of:
determining that a non-broadcast message is to be transmitted to the node; and
transmitting the non-broadcast message during the sleep interval.

6. The method of claim 5 wherein the non-broadcast message comprises a unicast message.

7. The method of claim 1 wherein the broadcast message comprises a message that does not require a response from a node.

8. The method of claim 1 wherein the step of transmitting the broadcast message comprises the step of transmitting the broadcast message to more than one node.

9. The method of claim 1 wherein the step of transmitting the broadcast message during the awake interval comprises the step of setting a bit in a frame control field of a broadcast data frame header to FALSE when there are no further broadcast messages to transmit.

10. In a communication system employing an awake interval where all nodes remain awake to receive and transmit messages, and also employing a sleep interval where nodes may sleep if they have no messages to receive, a method for message reception, the method comprising the steps of:
receiving a broadcast message during the awake interval if the broadcast message length is below a threshold, otherwise; and
receiving the broadcast message during the sleep interval.

11. The method of claim 10 wherein the threshold comprises is based on if the broadcast message will fit within the awake interval.

12. The method of claim 10 wherein the step of receiving the broadcast message during the awake interval comprises the step of receiving the broadcast message during an IEEE 802.11 ad-hoc traffic indication (ATIM) window.

13. The method of claim 10 wherein the step of receiving the broadcast message during the sleep interval comprises the step of receiving the broadcast message during an IEEE 802.11 post ad-hoc traffic indication (ATIM) window.

14. The method of claim 10 further comprising the steps of:
receiving a non-broadcast message during the sleep interval.

15. The method of claim 14 wherein the non-broadcast message comprises a unicast message.

16. The method of claim 10 wherein the broadcast message comprises a message that does not require a response from a node.

17. In a communication system employing an awake interval where all nodes remain awake to receive and transmit messages, and also employing a sleep interval where nodes may sleep if they have no messages to receive, an apparatus for message transmission, the apparatus comprising:
logic circuitry determining that a broadcast message is to be transmitted to a node and determining if the broadcast message size is below a threshold; and
transmission circuitry transmitting the broadcast message during the awake interval if the broadcast message is below the threshold, otherwise transmitting the broadcast message during the sleep interval.

18. The apparatus of claim 17 wherein the logic circuitry determines if the broadcast message size is below the threshold by determining if the broadcast message will fit within the awake interval.

19. The apparatus of claim 17 wherein the awake interval comprises an IEEE 802.11 ad-hoc traffic indication (ATIM) window.

20. In a communication system employing an awake interval where all nodes remain awake to receive and transmit messages, and also employing a sleep interval where nodes may sleep if they have no messages to receive, a method for message transmission, the method comprising the steps of:
determining that a plurality of broadcast messages are to be transmitted to a plurality of nodes;
determining that multiple broadcast messages from the plurality of broadcast messages that are to be transmitted have a length that is below a threshold;
transmitting a single broadcast message that is below the threshold during the awake interval; and
transmitting all remaining broadcast messages that are below the threshold during the sleep interval.
